(19) United States
(12) Patent Application Publication
(10) Pub. No.: US 2007/0282781 A1
(43) Pub. Date: Dec. 6, 2007

(54) Method To Retrieve Data For An Equipment, Plant Or A Process

(76) Inventors: Mogens Mathiesen, Oslo (NO); Pierre Oberg, Vasteras (SE); Stefan Svensson, Vasteras (SE)

Correspondence Address: VENABLE LLP, P.O. BOX 34385, WASHINGTON, DC, 20043-9998, US

(21) Appl. No.: 10/583,982

(22) PCT Filed: Dec. 17, 2004
(86) PCT No.: PCT/SE04/01937

§ 371 Date: Apr. 23, 2007

(30) Foreign Application Priority Data
Dec. 22, 2003 (SE) 0303534-2

(51) Int. Cl. G06F 17/30

(52) U.S. Cl. 707/1; 707/E17.001

(57) ABSTRACT

A method to retrieve and/or access information about an equipment, plant or process in a facility including a plurality of devices and one or more control systems for process monitoring and control, wherein energy-related information and other data for each said device is stored in a the control system. A software entity is configured with an identity of a selected the equipment, plant or process. Information associated with the equipment, plant or process is retrieve with the configured software entity. At least information about a new event or alarm for the device and/or the location of the equipment, plant or process about to a user is presented or displayed.

### TECHNICAL AREA

This invention relates to a method and a system for retrieving and/or accessing data for an equipment, plant or a process. In particular, and not exclusively, the invention provides a means to access and retrieve technical information necessary to carry out maintenance and/or repair measures.

### TECHNICAL BACKGROUND

Monitoring and control of plant and equipment in industrial facilities is largely automated and computerised. A traditional automation system is one in which each physical asset is described in a database. In its turn, this database is frequently modeled as a multitude of tables, and relationships between different fields and tables in the database. Process monitoring and control software operates using, in part, data stored in a flat file or relational or relational distributed databases. This approach has certain disadvantages. The principle disadvantage is that when a change is needed in the information structure or the software that operates related applications, there are usually many updating tasks required to accommodate changes, resulting in a software system that is difficult to manage and update.

Object-oriented systems have been proposed as an improvement on database-based systems. From the international patent application WO 01/02953 it is known to represent real world objects in control systems by means of one or more software components. The real world object may be a single device, an object in a process or complete equipment. The real world objects to be controlled are represented as first software components called composite objects. The system also includes second software entities called aspect objects, which are placeholders for data and/or operations of the real world object. The aspect objects are provided with an interface for entry of and retrieval of data; and for invoking functionality (methods). The composite object is a container holding at least one aspect representing a link to data for the real world object. The composite object includes information leading to one or more interfaces of aspect objects.

Although much technical information about various devices, equipment, process sections etc exists, it is most often distributed among different systems each having different categories of data and/or different methods of storing and retrieving technical data. Examples of such systems are computerized maintenance systems, process control systems, power management systems, energy management systems, and systems for process simulations and optimization. Examples of information to be found in such systems are production flows, compressor efficiency curves, references to load characteristics of drive solution, energy consumption logs, ratings for electric motors, information about material costs and energy costs. An installation may also include equipment from different suppliers and from different industries. It is a complex and difficult task to retrieve information from all of those systems so as to give a reliable and extensive picture even on a historical basis. It is also very difficult, time consuming and error prone to organize, enter, maintain and retrieve information related to a specific device. It is even more difficult to retrieve and or access such information when a alarm or other event is reported.

However the prior art does not provide access to plant and process section information in a timely way that supports fast or on-line technical decisions for operation and/or optimization of production or of a process, plant, or other production or processing site.

### SUMMARY OF THE INVENTION

The present invention aims to solve one or more of the above problems.

According to one aspect of the invention, the object is achieved by the initially defined method comprising configuring a software entity with an identity of a selected said equipment, plant or process, retrieving information associated with said equipment, plant or process by means of the configured software entity, and presenting or displaying at least retrieved information about a new event or alarm for said device and/or the location of said equipment, plant or process about to a user.

According to another embodiment, the method comprises steps to find one or more internal users with technical information relevant to equipment, plant or process. This embodiment uses a software entity means to include extensive information in a user profile that may be later retrieved to identify users with access to technical information of interest.

According to another embodiment, the method comprises steps to configure a selected technical characteristic of the selected said equipment, plant or process with an indicator criticality so as to specify a high, medium or low priority for returning the selected said equipment, plant or process to a normal state.

According to another aspect of the invention, the aims are achieved by a software architecture for retrieving and accessing information about an equipment, according to claim 15.

According to another aspect of the invention, the aims are achieved by an initially defined control system according to claim 19.

A major advantage of the present invention is that a maintenance action to respond to a new alarm or other event may be handled in a more ordered way. Internal users with recorded technical information and/or expertise may be quickly identified and contacted, and where necessary external experts or consultants may also be quickly identified and/or contacted.

As much of the invention is implemented in software the necessary time and capital cost of including the invention in both new installations and existing installations is relatively low and therefore very advantageous.

According to another aspect of the invention, the aims are achieved by a computer program directly loadable into the internal memory of a computer or processor, comprising software code portions for performing the steps of the method according to the invention, when said program is run on a computer or processor. The computer program is provided either on a computer readable medium or through a network, such as a local area network or a wide area network including the Internet.

According to still another aspect of the invention, the objects are achieved by a computer-readable medium having at least one program recorded thereon, where the program is to make a computer or processor perform the steps of the method according to the invention, when said program is run on a computer or processor.

### BRIEF DESCRIPTION OF THE DRAWINGS

Embodiments of the invention will now be described, by way of example only, with particular reference to the accompanying drawings in which:

FIGS. 1a, 1b is a schematic flowchart for a method or process to access information about an equipment, plant or process for maintenance or repair purposes according to an embodiment of the invention.

FIG. 2 is a schematic diagram of a screen display showing a software entity in an object oriented control system configured to comprise an Expert member according to an embodiment of the invention;

FIG. 3 is a schematic diagram of a screen display showing a selection of maintenance priority details for a selected software entity for which information has been gathered by a such Expert member;

FIG. 4 is a schematic screen display showing a selected maintenance priority level;

FIG. 5 is a schematic screen display showing some retrieved information for a selected software entity representing an equipment, plant or process.

### DETAILED DESCRIPTION OF THE EMBODIMENTS

In a first embodiment the method relates to securing technical information from a local or internal colleague relevant to a device, apparatus or problem that the person is trained for or responsible for. A maintenance person requiring technical information picks up or preferably puts on a user equipment, which may be a PDA, wearable computer, headset based device. To deal with an incoming alarm, the control system tells the logged on maintenance person where in the plant to go and what the problem is (the system may indicate a new alarm via text, a display, or text-to-speech (TTS). The maintenance person user can ask for more info via text or voice. The maintenance person goes to a physical location and or a location of a plant or process section (functional location) indicated by the system, observes the problem, alarm or other event. The maintenance person can enter a new text or voice operator note regarding the problem, and he can view service history and documentation, such as for example:
1. lists with instructions from the supplier of the particular object
2. top 5 problems for this particular device or item
3. view or listen to operator notes recorded at an earlier date by an operator who has fixed problems in the past (may even be his own notes).

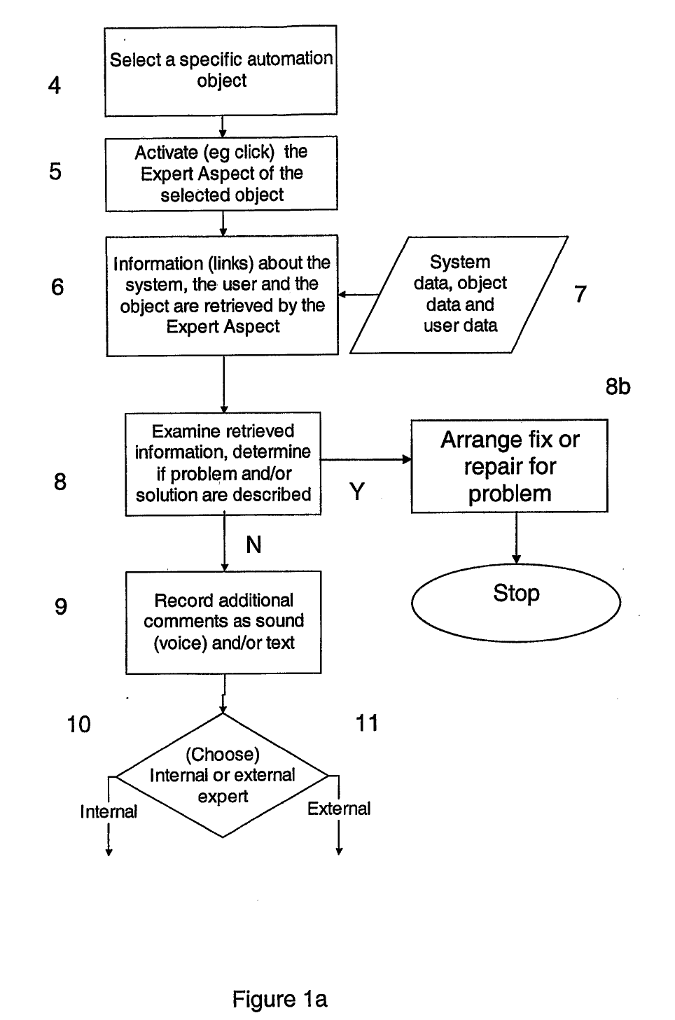

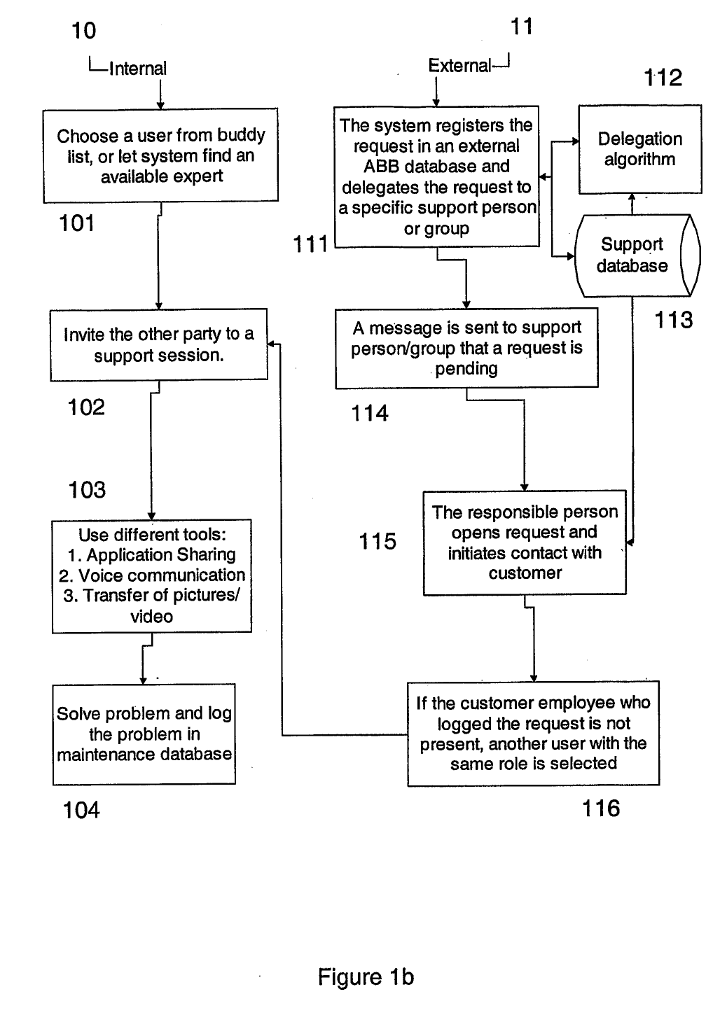

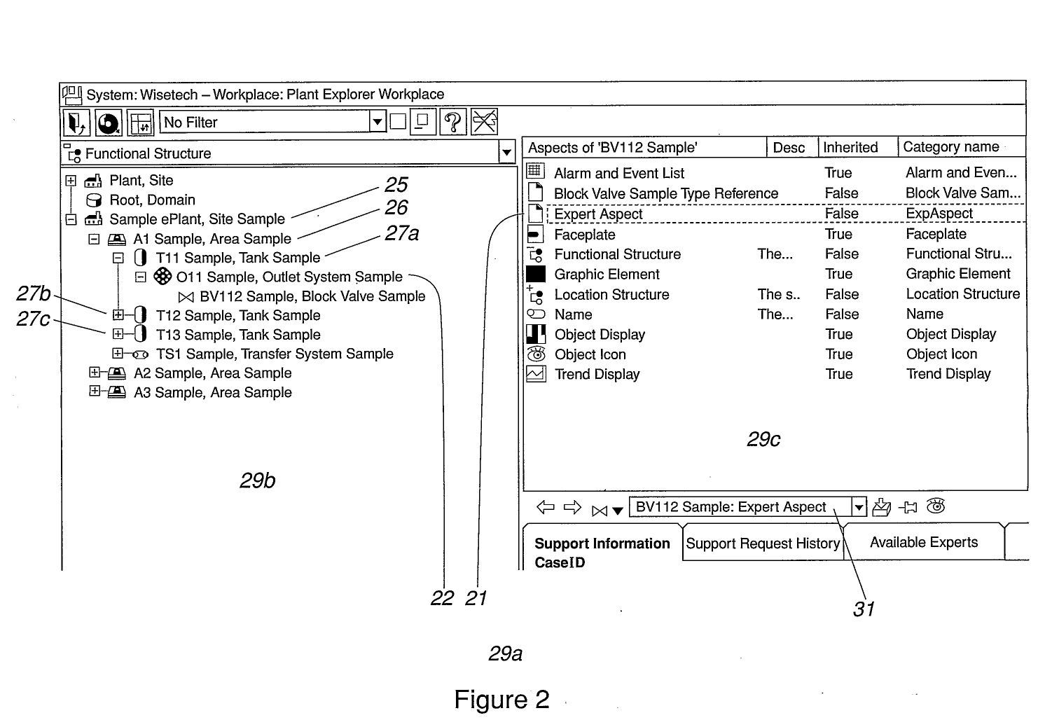

If the maintenance person cannot fix the problem on his own, and needs help/support, he activates or mouse-clicks the expert aspect in the control system associated with the device or problem of interest (see below 4, 5 FIG. 1a, and 21, 22 FIG. 2 and below for more details). The system finds an appropriate online expert (using the history of previous similar problems) or the user picks a specific person, and contact is established. The second person agrees to accept support request and the system gives an overview of the situation. Voice contact is established automatically via voice-over-IP (VoIP). There is also an option of application sharing or to send pictures or files.

Second scenario is assistance from a “support line” of an outside organisation, eg from ABB Support. In the case where the maintenance person has not been successful in fixing a problem according to the previous scenario using help from a local colleague. He then chooses to get support directly from ABB by clicking “remote expert”, which system may then retrieve necessary system and device or process information (Company Name, User Name, System Type, System Information, Information about the faulty item, and other relevant process data). The user has the option to attach a picture or video clip, and can also enter an operator note via voice or text. When the support request is finished, it is registered in a database and an email is sent to eg ABB Support so that they can help fix the problem.

To configure the software entity, the Expert Aspect, that retrieves the stored technical information relevant to a device or system, an an Expert Configuration Aspect must be used. This is a configuratiuon aspect where one enters the information that is required by the Expert Aspect. This information includes a unique address, internally with IP addresses and workstation addresses of users internal to the plan, and, preferably for external experts an IP address of the ABB support database and information about the local system to be used in support requests.

The Expert Aspect uses the following functionality: Automatic gathering of system-, user-, and object data The possibility of attaching video, voice or pictures to a support request, and retrieving a “buddy-list” to give an overview of available local experts. It may be desirable to add some logic to the list so that local contacts with knowledge about a specific problem are given priority, and so that the logic establishes which users or experts are now available, logged in, on call, suitable but not available, when available and why.

Application sharing. Two logged on users of the same control system running the Expert Aspects can view the same information even though they are in different places. Voice-over-IP or other voice communication. Voice communication is automatically set up between the user and the expert to facilitate support.

There is a difference between local experts and remote (eg ABB Support) experts. The difference lies in the fact that support from remote experts is most often asynchronous at first, whilst contact with a local expert is typically synchronous from the beginning. Both types of support are described in the following flow chart.

FIG. 1a shows steps of a method to retrieve or access technical information for an equipment, plant or process in a facility. A user such as an properly logged-in operator, technician, engineer has a technical problem concerning a fault, alarm or event for a device controlled by a control system that comprises the invention.

Referring to FIG. 1. The user selects a software entity 4 displayed on a display screen by the control system and activates 5 a function of the software entity in the control system called an Expert Aspect. The Expert Aspect is a second type of software entity that enables characteristics of or data about any equipment, plant, process or device controlled by the control system to be selected and then on request, retrieved. The user examines the information associated with that instance, that software entity, representing an item of equipment etc, information such as a specification, a historical log, maintenance records, supplier information and other information thus accessed and/or retrieved; if the information made available is sufficient he fixes 8b or arranges for a fix for the problem.

If not, the user records 9 any additional observations or information he or she may have in the form of sound files, video clips, photographs and/or text. These observations are then also stored in the control system, retrievable through the Expert Aspect of the entity of interest.

The user then selects to seek further information either internally 10 from a local or company internal source, or externally from a remote and/or third party source. FIG. 1b shows an internal route for information identification and retrieval beginning with a selection 101 either from a list of local other employees or other known technicians, a buddy list, or for the control system to select a person from the all internal lists. A selected person is then contacted 102 with a short description of the problem together with a maintenance priority level dependent on how critical the item is in the process. The selected person is invited to contribute and answer a request for technical information. The nature of the problem and information relevant to the problem may then be exchanged 103 by any of application sharing, voice communication via phone or IP phone, and/or transfer of pictures or video. A technical solution is then determined 104 and the problem recorded in a maintenance log and/or database.

FIG. 1b also shows an external route for information identification and retrieval beginning with a registration 111 in a database of an external supplier, followed by a determination 112 of to whom the problem shall be delegated. The delegation algorithm of 112 takes into account problem data, solution data information in the support database 113 as well as any other information already gathered in step 6 of FIG. 1a by the Expert Aspect. A contact is then made 114 to a selected support group or person that an information request is pending. A person thus contacted then makes contact with the reporting user 115 or other person nominated 116 or substituted by him. After this point the process is the same as steps 102-104 of the internal route.

FIG. 2 shows a screen capture of an example of a representation of two installations or plants or other grouping of industrial devices by means of an object oriented control system according to one embodiment of the present invention. In the left panel 29b a tree-like arrangement may be seen called Sample ePlant 25. The ePlant is shown here broken down into a series of Sample processes 27a, 27b, 27c each of which include a Sample Tank. At the next level of detail, Sample Tank T11, 27a, is shown to comprise O11 Sample, an outlet system apparatus, which in turn at another level of detail comprises a block valve. A software object 22 representing the Block Valve Sample, BV112 Sample, arranged in the Outlet system to Sample tank T11, 27a, is shown selected, in shadow, in the left panel.

In the right panel 29c a series of software functions are displayed dependent on the one selected software object 22, for the Block Valve Sample shown selected in the left panel 29b. It can also be seen that most of the functions may be configured to be inherited or not, which will be described more fully below in relation to parent-child functionality. The series of software functions displayed as a result of selecting the Block Valve Sample object 22 in the Outlet system of Sample Tank T11 in the Sample ePlant includes an Expert Aspect 21, which is shown in this display to be activated. Also visible in the right panel is the top of an open Expert Aspect window 31 displaying information gathered by the Expert Aspect 21 belonging to the block valve 22.

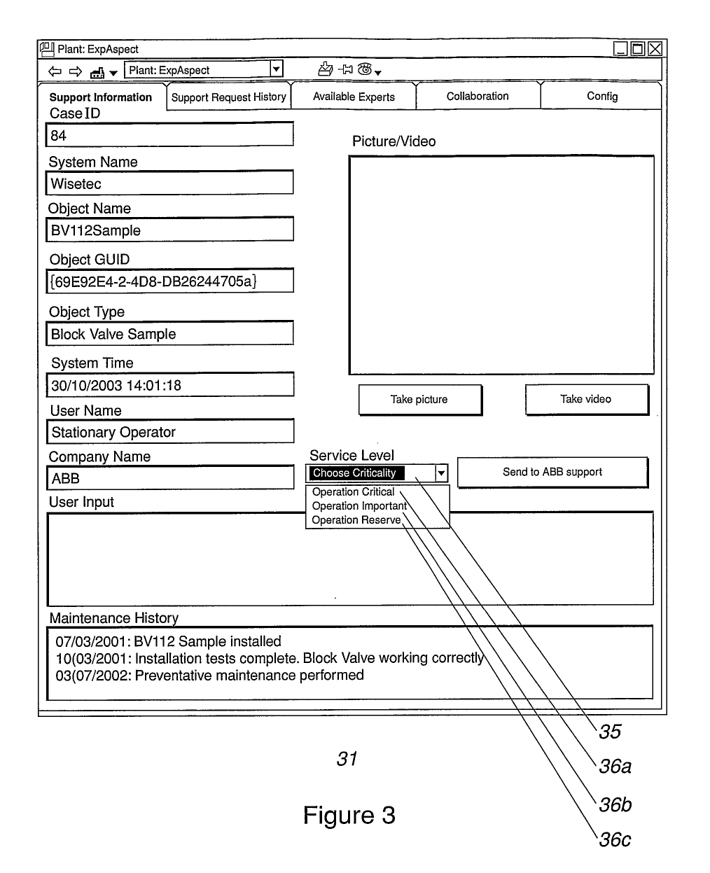

FIG. 3 shows the information processing functions for the block valve Expert Aspect 21 displayed by the Expert Aspect window 31 in a series of connected panels. The component in question, the block valve 22 of FIG. 2, is configured to have a technical or maintenance criticality, Service Level 35, depending at least on the function or functions it carries out in the plant. Thus, a safety critical item would be classified as Operation Critical 36a. Other criticalities include classifications such as Operation Important 36b, Operation Reserve 36c and so on.

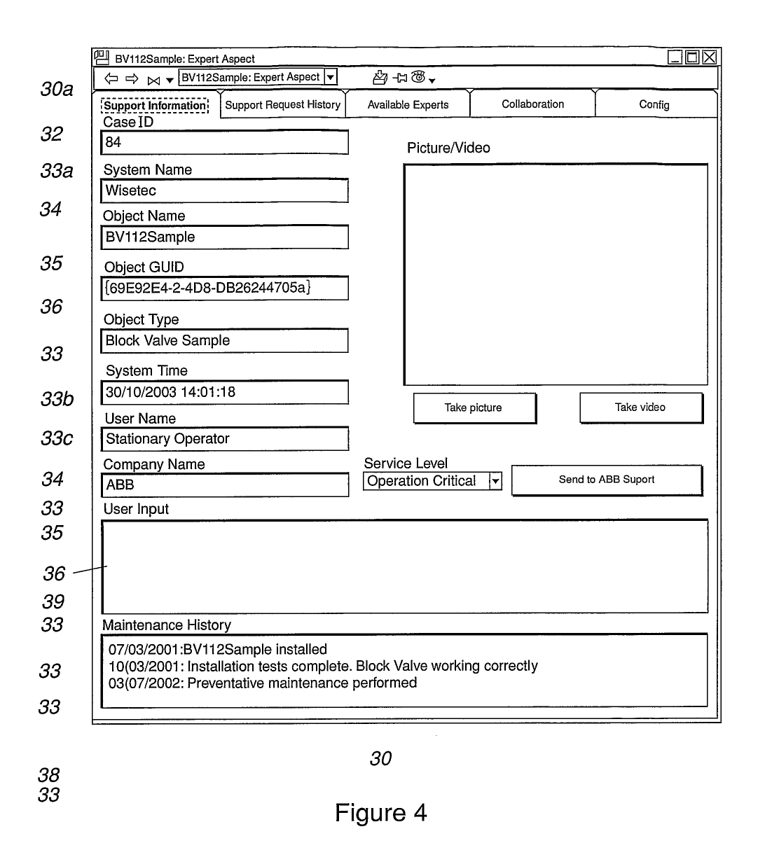

FIG. 4 shows the block valve Expert Aspect 21 displayed by the Expert Aspect window 31 and configured with a service level of Operation Critical 30. The component in question, the block valve 22 of FIG. 2, is shown to have a unique global ID, or GUID also configured in the software entity which enables that unique instance of the type of block valve to be identified and controlled.

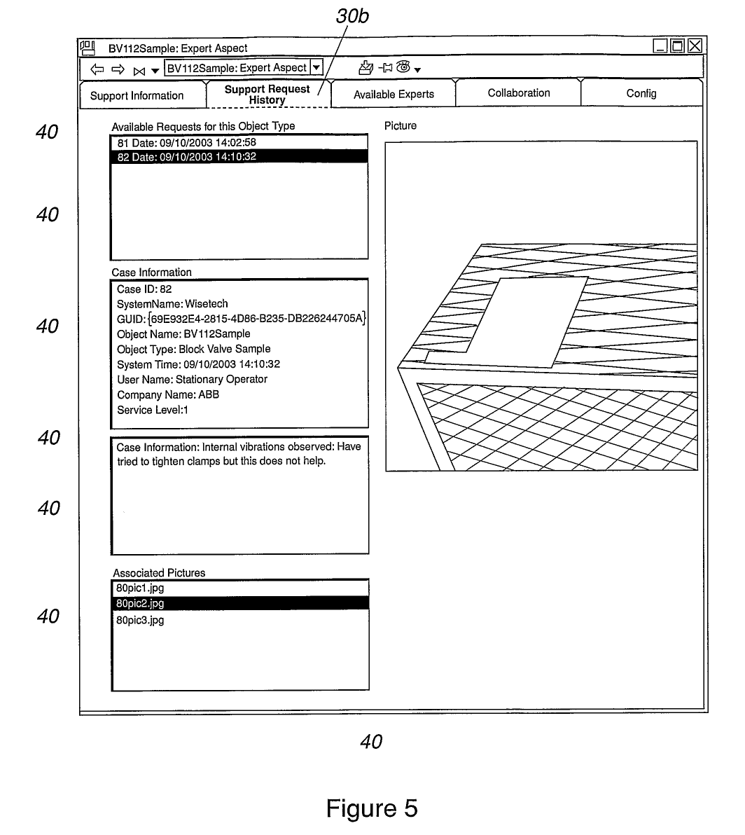

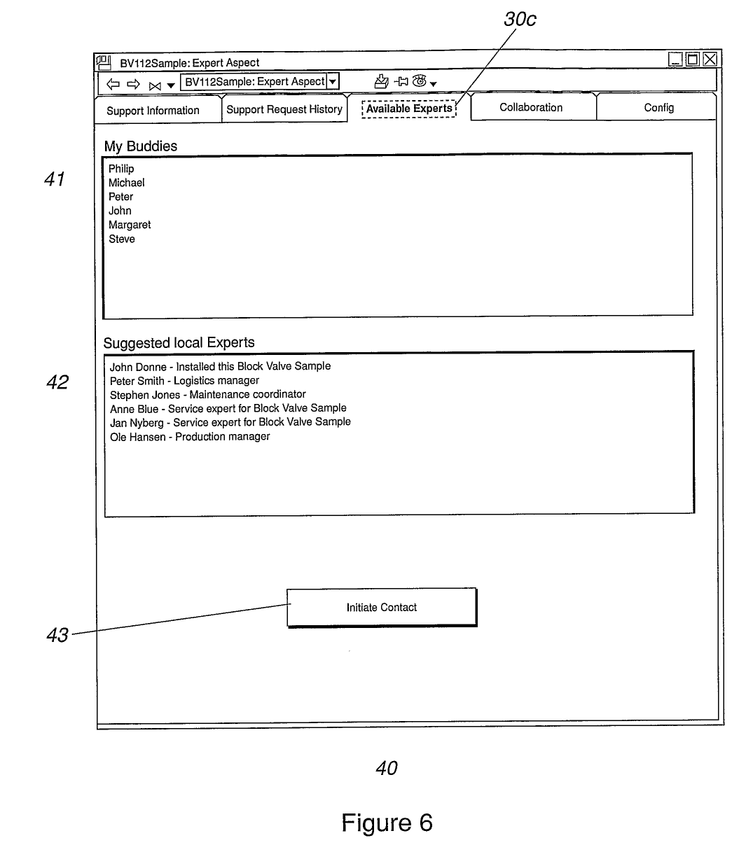

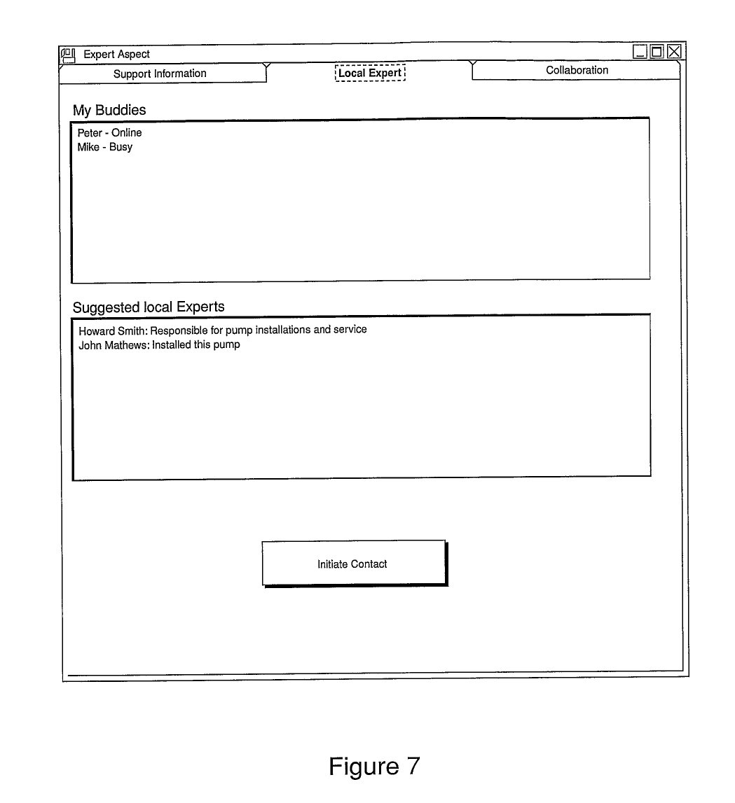

FIG. 5 indicates that graphic information may be included as a photograph or video clip to provide information relevant to a device. FIG. 6 shows a display of colleagues or buddies who may have the requisite technical information. It also shows a list of local or internal experts who should have the technical information necessary to take action to remedy an alarm or fault. A similar display of contactable external experts may also be made available.

A user profile as practiced in the prior art may consist of information and or data relevant to a user that logs in to a system, which information is stored in a flat file or relational database or relational distributed databases. In the control system according to the invention, each type of plant, device or system may be named according to type of object in the control system, a Type T Block Valve 22, an electrical distribution panel, a centrifugal pump, an ABB AC800 controller and so on. Each user that has log-on rights in the organisation owning the industrial facility may have certain technical attributes included in their user profile. Thus an operator may have information similar to the following items listed in his/her profile:

User 123

Password ***
Plant access: plant section A; plant section B;
Operation: production, plant section A
Operation: production, plant section B
Operation: maintenance, plant section A
Operation: T11 Sample Tank; take sample
Technical: sand filter A100; section A start up;

A maintenance person may have items of information such as the following listed in his/her profile:

User 345

Password ***
Plant access: plant section A; plant section B; plant section C; plant section D;
Operation: maintenance: start up; shut down; plant section A; plant section B;
Operation: maintenance: electrical test 101
Operation: production, plant section B
Operation: maintenance, plant section A
Technical: main breakers A; B; C; D;
Technical: fire hydrants; fire sprinklers;
Technical: sand filter A100; section A start up;

In particular safety-critical information may be recorded. User profiles may be configured to indicate those persons who have been nominated as technically responsible should events such as fire, chemical leaks, boiler or high pressure steam problems and the like occur. The information may be based according to persons who have received training, technical or training to standards recognised by professional or government organisations.

Contact information to external agency information, to Fire authorities, Hazard centres, Biological Coordination centres and so on where considered relevant by the responsible engineers may also be recorded in Aspects, software entities, representing one or more sections of equipment or the plant or facility in the control system of the plant.

In a preferred embodiment the user profile is implemented as a functional software entity or system of software entities. Instead of a user profile consisting of data in flat files, tables or databases of the prior art, the user profile is implemented as an Aspect entity. Thus configuration or updating of one or more user profiles may be carried out, amongst others, by changing a position of the User Aspect in a structure, eg moving a user object from plant location A to plant location B may simultaneously change the respective user's access privileges from access to plant location to access only to plant B and not A.

The Expert Aspect retrieves on demand all information for any selected named devices, objects and systems in the plant, and named operations on them that take place in the plant. The Expert Aspect is an inventive software entity holding links to characteristics for every control object represented in the control system for retrieving technical information. The Expert Aspect, or a program or software agent working on the Expert Aspects, may retrieve all information held by Expert Aspects about one or more specified, known objects. In this way, a local or internal maintenance person with technical information and/or experience and/or training about fixing device A or system B may be identified.

Similarly, manufacturers information, remotely stored information or external expert held information may also be retrieved by searching all records in a database of the control system for external technical information about a selected device A or a system B.

The Expert Aspect retrieves not only the type of information that some systems or control systems or maintenance systems of the prior art might each separately retrieve; such as equipment operation logs, logged sensor data, maintenance records, stored manufacturer information, drawings. The Expert Aspect also comprises inventive means to identify an identified “expert” according to information configured in an Aspect of the device or system matched to n internal user aspect (implementing a user profile) or to an external person's user profile. The Expert Aspect also comprises inventive means to both identify and also contact an identified internal or external “expert”.

The contact means and method may typically be a unique address to a workstation where the person is currently logged on. The means may be a phone number or IP phone number of an internal or external person holding expert information. The expert Aspect may also run one or more programs or algorithms to analyze availability, such as a delegation algorithm, and retrieve information and present information to show, for example that in respect of Block Valve 22 there is an internal expert identified who is not available until the next day-shift, and there is an external expert in a consulting engineering company who is available on-line at the present time.

Thus for operation-critical and especially for safety-critical apparatus, systems or plant sections, technical information may be rapidly retrieved and/or expert technical assistance to deal with an alarm or other event may be rapidly contacted by means of the automated methods for retrieving information related to a named equipment, device or system stored in the plant control system.

The methods of the invention may be carried out by means of one or more computer programs comprising computer program code or software portions running on a computer, data server or a processor. The microprocessor (or processors) comprises a central processing unit CPU performing the steps of the method according to one or more facets of the invention, such as the methods shown in FIGS. 1a, 1b. The methods are performed with the aid of one or more said computer programs, which are stored at least in part in memory accessible by the one or more processors. For example a program or part-program that carries out some or all of the steps 4-116 shown and described in relation in FIGS. 1a and 1b may be run by a computer or processor of the control system. At least one of the or each processors may be in a central object oriented control system in a local or distributed computerised control system. It is to be understood that said computer programs may also be run on one or more general purpose industrial microprocessors or computers instead of one or more specially adapted computers or processors.

The computer program comprises computer program code elements or software code portions that make the computer perform the method using equations, algorithms, data, stored values and calculations previously described. A part of the program may be stored in a processor as above, but also in a ROM, RAM, PROM, EPROM, or EEPROM chip or similar memory means. The program in part or in whole may also be stored on, or in, other suitable computer readable medium such as a magnetic disk, CD-ROM or DVD disk, hard disk, magneto-optical memory storage means, in volatile memory, in flash memory, as firmware, stored on a data server or on one or more arrays of data servers. Other known and suitable media, including removable memory media such as removable flash memories, hard drives etc. may also be used. Data may also be communicated wirelessly, at least in part, to portable devices carried or worn by a user. Wireless communications may be carried out using any suitable protocol, including a wireless telephone system such as GSM or GPRS. Short range radio communication is a preferred technology, using a protocol compatible with, standards issued by the Bluetooth Special Interest Group (SIG), any variation of IEEE-802.11, WiFi, Ultra Wide Band (UWB), ZigBee or IEEE-802.15.4, IEEE-802.13 or equivalent or similar. In particular a radio technology working in, for example, the ISM band with significant interference suppression means by spread spectrum technology is advantageous. For example a broad spectrum wireless protocol in which each or any data packet may be re-sent at other frequencies of a broad spectrum 7 times per millisecond, for example, may be used, such as in a protocol from ABB called Wireless interface for sensors and actuators (Wisa). Wireless communication may also be carried out using Infra Red (IR) means and protocols such as IrDA, IrCOMM or similar. Wireless communication may also be carried out using sound or ultrasound transducers, through the air or via work object construction, pure magnetic or electric fields (capacitive or inductive communication) or other types of light, such as for example LED, laser, as communication media with standard or proprietary protocols.

The computer programs described above may also be arranged in part as a distributed application capable of running on several different computers or computer systems at more or less the same time. Programs as well as data such as energy related information may each be made available for retrieval, delivery or, in the case of programs, execution over the Internet.

Data and/or methods may be accessed by software entities or other means of the control system by means of any of the lost of: OPC, OPC servers, an Object Request Broker such as COM, DCOM or CORBA, a web service.

It is also noted that while the above describes exemplifying embodiments of the invention, there are several variations and modifications which may be made to the disclosed solution without departing from the scope of the present invention as defined in the appended claims.

1. A method to retrieve and/or access information about an equipment, plant or process in a facility comprising a plurality of devices and one or more control systems for process monitoring and control, wherein energy-related information and other data for each said device is stored in a said control system, the method comprising:
configuring a software entity with an identity of a selected said equipment, plant or process,
retrieving information associated with said equipment, plant or process by means of the configured software entity, and
presenting or displaying at least information about a new event or alarm for said device and/or the location of said equipment, plant or process about to a user.

2. The method according to claim 1, further comprising:
retrieving the information associated with said equipment, plant or process by means of the software entity, and
finding one or more internal users with technical information relevant to equipment, plant or process.

3. The method according to claim 2, further comprising:
assigning the new event or alarm for said equipment, plant or process to an internal user.

4. The method according to claim 2, further comprising:
retrieving an address for an external user or expert and presenting the address to the internal user.

5. The method according to claim 4, further comprising:
establishing contact between the external user or expert and the internal user.

6. The method according to claim 4, further comprising:
establishing a shared display or shared computer application contact between the external user or expert and the internal user.

7. The method according to claim 1, further comprising:
configuring a selected technical characteristic of the selected said equipment, plant or process with an indicator of a high, medium or low priority for returning the selected said equipment, plant or process to a normal state.

8. The method according to claim 1, further comprising:
configuring a technical information link of component of a said equipment, plant or process with an identity of a user with access to relevant technical information.

9. The method according to claim 8, further comprising:
configuring said equipment, plant or process with an identity of a user with dependent on information recorded in the user profile.

10. The method according to claim 8, further comprising:
configuring said equipment, plant or process with an identity of a user with dependent on information recorded in the user profile classified by any from the list of: responsibility, training, certified qualification, work experience.

11. The method according to claim 1, further comprising:
attaching a user observation to the retrieved information associated with said equipment, plant or process as any form the list of: a text message, a video clip, a photograph, sketch, sound recording.

12. The method according to claim 1, further comprising:
carrying out a repair, re-configure, re-programming or replacement of a faulty part of said equipment, plant or process based at least in part on technical information associated with said equipment, plant or process retrieved and/or presented by means of the software entity.

13. A computer program product for retrieving and/or accessing information about an equipment, plant or process, comprising:
a computer readable medium; and
computer code means and/or software code portions recorded on the computer readable medium which when run on a computer or processor will make said computer or processor perform the steps
configuring a software entity with an identity of a selected said equipment, plant or process,
retrieving information associated with said equipment, plant or process by means of the configured software entity, and
presenting or displaying at least information about a new event or alarm for said device and/or the location of said equipment, plant or process about to a user.

14. (canceled)

15. A software architecture for retrieving and accessing information about an equipment, plant or process in a facility comprising a plurality of devices and one or more control systems for process monitoring and control, wherein energy-related information and other data for each said device is stored in a said control system, said architecture comprising at least one public interface, that a software entity of said architecture comprises
means to configure an interface of a software entity representing characteristics of one or more components of said equipment, plant or process, and
means to access or retrieve an interface to access information about a known component in said equipment, plant or process.

16. The software architecture according to claim 15, further comprising:
means to retrieve a unique ID or address for a workstation or similar of a user with access to relevant technical information.

17. The software architecture according to claim 15, further comprising:
means to retrieve an IP address for a local user with access to relevant technical information.

18. The software architecture according to claim 15, further comprising:
means to retrieve an IP address for a remote or external user with access to relevant technical information.

19. A control system for a plant or process in a facility comprising a plurality of devices and one or more control systems for process monitoring and control, wherein energy-related information and other data for each said device is stored in a said control system, the control system comprising:
one or more software entities for retrieving and presenting information associated with said equipment, plant or process, and
means to assign a maintenance or other action as a response to a new alarm or event to a user.

20. Use of a control system according to claim 19 for scheduling and assigning a maintenance or other action as a response to an alarm or event in a plant or process in a facility comprising a plurality of devices and one or more control systems for process monitoring and control.
